(19) United States
(12) Patent Application Publication
(10) Pub. No.: US 2014/0267670 A1
(43) Pub. Date: Sep. 18, 2014

(54) MOBILE MICROSCOPY DEVICE AND METHOD THEREFOR

(71) Applicants: Pooncharas Tipgunlakant, San Francisco, CA (US); Lester F. Ludwig, San Antonio, TX (US)

(72) Inventors: Pooncharas Tipgunlakant, San Francisco, CA (US); Lester F. Ludwig, San Antonio, TX (US)

(21) Appl. No.: 13/844,634

(22) Filed: Mar. 15, 2013

(51) Int. Cl. G02B 21/36; H04N 5/225

(52) U.S. Cl. CPC G02B 21/361; H04N 5/2256
USPC 348/79

(57) ABSTRACT

A mobile microscopy apparatus usable in connection with a mobile computing device comprising a memory unit and camera, the mobile microscopy apparatus comprising: an illumination module for illuminating a removable media with an illuminating light, an image acquisition optics for creating an image of the sample for acquisition by the camera of the mobile computing device, and a mounting frame assembly for detachably mounting the illumination module and the image acquisition optics to the mobile computing device and for holding the removable media in a predetermined position. In various implementations, the illumination module may provide either backside or frontside illumination of the removable media using the light generated by a light source of the mobile computing device. The mobile microscopy apparatus may operate in the microscope configuration, visible colormatic microarray configuration, and/or fluorescent microarray configuration.

### BACKGROUND OF THE INVENTION

1. Technical Field

The disclosed embodiments relate in general to mobile computing devices and, more specifically, to systems and methods for implementing a mobile microscopy tool using a mobile computing device, such as a smartphone, and the associated image acquisition and analysis functionality.

2. Description of the Related Art

Conventional microscopy devices used in the medical and scientific fields are large, expensive and do not have the necessary communication interfaces and software tools designed to leverage the multitude of online data available to aid in the image analysis and data processing. There is a strong need for inexpensive network-connected mobile microscopy devices for medical and scientific applications. Such devices would be indispensible for a variety of real-life applications, including food and water testing as well as disease diagnosis, especially in geographical locations with shortages of medical personnel and diagnostic equipment.

Therefore, improved mobile microscopy tools are needed.

### SUMMARY OF THE INVENTION

The embodiments described herein are directed to methods and systems that substantially obviate one or more of the above and other problems associated with conventional microscopy tools.

In accordance with one aspect of the inventive concepts described herein, there is provided a mobile microscopy tool usable in connection with a mobile computing device comprising a camera, the mobile microscopy tool comprising: an illumination module for illuminating a removable medium with an illuminating light, an image acquisition optics for creating an image of the sample for acquisition by the camera of the mobile computing device, and a mounting frame assembly for detachably mounting the illumination module and the image acquisition optics to the mobile computing device and for holding the removable medium in a predetermined position in relation to the illumination module and the image acquisition optics.

In various embodiments, the memory unit of the mobile computing device comprises: an image acquisition module for acquitting an image of the sample using an illuminating light; an image analysis module for analyzing the acquired image using image recognition algorithm; and a network communication module for communicating the acquired image across a communications network.

In various embodiments, illumination module comprises a light guide optically coupled with a light source of the mobile computing device, the light guide configured for delivering the light from the light source of the mobile computing device to the removable medium.

In various embodiments, the light guide comprises light shielding for reducing light leakage.

In various embodiments, the illumination module is a backside illumination module configured to illuminate the side of the removable medium opposite to the side of the camera of the mobile computing device.

In various embodiments, the illumination module is a frontside illumination module configured to illuminate the same side of the removable medium as the camera side.

In various embodiments, the illumination module comprises a mirror configured to direct a light from a light source of the mobile computing device onto the removable medium.

In various embodiments, the illumination module comprises a mirror configured to direct a light from a light source of the mobile computing device onto the removable medium.

In various embodiments, the illumination module comprises a light pipe configured to direct a light from a light source of the mobile computing device onto the removable medium.

In various embodiments, the light pipe comprises a light guide portion and an illuminating portion.

In various embodiments, the illumination module comprises a diffuser for improving uniformity of illumination of the removable medium.

In various embodiments, the illumination module comprises an apodizing filter for improving uniformity of illumination of the removable medium.

In various embodiments, the illumination module comprises a wavelength shifter.

In various embodiments, the illumination module comprises an ultra violet light source.

In various embodiments, the image acquisition optics comprises an objective lens.

In various embodiments, the removable medium is a microarray.

In various embodiments, the removable medium comprises a transparent material.

In various embodiments, the removable medium comprises a material holding portion and an encoded data portion.

In various embodiments, the image analysis module is configured to analyze the acquired image using a fluorescent microarray imaging technique.

In various embodiments, the image analysis module is configured to analyze the acquired image using a fluorescent microarray imaging technique.

In various embodiments, the image analysis module is configured to analyze the acquired image using a colorimetry imaging technique.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of the inventive mobile microscopy device.

FIG. 2 illustrates another exemplary embodiment of the inventive mobile microscopy device.

FIG. 3 illustrates an exemplary embodiment of the inventive mobile microscopy device having an opening for receiving a removable media, such as a slide or microarray.

FIG. 4 illustrates another exemplary embodiment of the inventive mobile microscopy device having an opening for receiving a removable media, such as a slide or microarray.

FIG. 5 illustrates yet another exemplary embodiment of the inventive mobile microscopy device having an opening for receiving a removable media, such as a slide or microarray.

FIG. 6 illustrates yet another exemplary embodiment of the inventive mobile microscopy device having an opening for receiving a removable media, such as a slide or microarray.

FIG. 7 illustrates an exemplary embodiment of the inventive mobile microscopy device coupled with the mobile computing device.

FIG. 8 illustrates another exemplary embodiment of the inventive mobile microscopy device coupled with the mobile computing device.

FIG. 9 illustrates yet another exemplary embodiment of the inventive mobile microscopy device coupled with the mobile computing device.

FIG. 10 illustrates yet another exemplary embodiment of the inventive mobile microscopy device coupled with the mobile computing device.

FIG. 11 illustrates yet another exemplary embodiment of the inventive mobile microscopy device coupled with the mobile computing device.

FIG. 12 illustrates yet another exemplary embodiment of the inventive mobile microscopy device coupled with the mobile computing device.

FIG. 13 illustrates yet another exemplary embodiment of the inventive mobile microscopy device coupled with the mobile computing device.

FIG. 14 illustrates yet another exemplary embodiment of the inventive mobile microscopy device coupled with the mobile computing device.

FIG. 15 illustrates an exemplary embodiment of a microarray.

FIG. 16 illustrates an exemplary embodiment of the wavelength shifter.

FIG. 17 illustrates an exemplary operating sequence of an image processing algorithm used in connection with an embodiment of the mobile microscopy device.

FIG. 18 illustrates an exemplary embodiment of an image acquisition algorithm used in connection with an embodiment of the mobile microscopy device.

FIG. 19 illustrates an exemplary embodiment of a computerized system for performing, among other tasks, image acquisition and analysis in connection with the inventive mobile microscopy device.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the inventive concepts described herein, there is provided a mobile microscopy device usable in connection with a mobile computing device comprising a camera, the mobile microscopy tool comprising: an illumination module for illuminating a sample with an illuminating light, an image acquisition optics for creating an image of the sample for acquisition by the camera of the mobile computing device, and a housing assembly for detachably mounting the illumination module and the image acquisition optics to the mobile computing device and for positioning the sample in a predetermined location for image acquisition.

FIG. 1 illustrates an exemplary embodiment of the inventive mobile microscopy device 101. In one embodiment, the mobile microscopy device 101, shaped as a cap, slides over one end of a mobile computing device 100, such as a smartphone, in the matter illustrated in FIG. 1. When the cap is placed over the mobile computing device 100, optical coupling is established between the camera and the camera flash of the mobile computing device 100 and the corresponding optical elements of the mobile microscopy device 101, as will be described in detail below. An alternative embodiment of the inventive mobile microscopy device, which is incorporated into a case or back cover 201 of the smartphone 100 is illustrated in FIG. 2. The mobile microscopy devices 101 and 201 may incorporate attaching mechanisms (not shown) for securing the respective mobile microscopy device to the mobile computing device 100. As would be appreciated by those of skill in the art, the inventive concepts are not limited only to the shown shapes of the mobile microscopy device 101 and any other suitable device shapes may be utilized without departing from the spirit and scope of the invention.

FIG. 3 illustrates an exemplary embodiment of the inventive mobile microscopy device 101 having an opening 301 for receiving a removable medium 302, such as a slide or microarray. In the embodiment shown in FIG. 3, the opening 301 is disposed at the top of the mobile microscopy device 101. In an alternative embodiment shown in FIG. 4, the receiving opening 301 is located on the side of the inventive mobile microscopy device 101. As would appreciated by those of skill in the art, the invention is not limited by specific location of the opening 301 and any other suitable opening locations may be used.

In the embodiment shown in FIG. 5, the size of the opening 501 is reduced compared to the size of the opening 301 of FIGS. 3 and 4. The opening 501 is designed to receive a mini-slide or a microarray 502 having a reduced size compared with the size of the removable medium 302, such as a slide or microarray. of FIGS. 3 and 4. Similarly, the opening 601 of the embodiment shown in FIG. 6 is also reduced in size. As would appreciated by those of skill in the art, the invention is not limited by specific size of the opening for receiving the slide, mini-slide or microarray.

FIG. 7 illustrates an exemplary embodiment of the inventive mobile microscopy device 101 coupled with the mobile computing device 100. The shown embodiment of the mobile microscopy device 101 incorporates a reflective backside illumination system 706 for providing a backside illumination light to the removable medium 302, such as a slide or microarray. The image of the removable medium 302 is acquired by the camera 701 of the mobile computing device 100 using image acquisition optics 703, which is placed into the optical path of the camera 701 to create an image of the illuminated removable medium 302 in the focal point of the aforesaid camera 701. In one or more embodiment, the image acquisition optics 703 is removable such that it could be replaced with a different acquisition optics having, for example, different magnification and/or field of view.

In one embodiment, the illuminating light is delivered to the reflective backside illumination system 706 of the mobile microscopy device 101 from the camera flash light emitting diode (LED) 702 of the mobile computing device 100. To this end, when the mobile microscopy device 101 is attached to the mobile computing device 100, the camera flash LED 702 of the mobile computing device 100 is placed into optical contact with the light guide 705. The light guide 705, in turn, is configured to deliver the light from the LED 702 of the mobile computing device 100 to the reflective backlight illumination system 706.

In one embodiment, the light guide 705 may be implemented using one or more optical fibers. In one or more embodiments, the light guide 705 incorporates a light shielding 707, for preventing light leakage from the light guide 705. In one embodiment, the light shielding 707 of the light guide 705 may be implemented using reflective coating created on the surface of the light guide 705. The reflective backside illumination system 706 is configured to convert the light received from the light guide 705 into illuminating light having required degree of uniformity and direct it onto the backside of the removable medium 302. In one or more embodiments, the backlight illumination system 706 may comprise one or more diffusers and/or optical filters placed into the optical path of the illumination light delivered by the light guide 705 in order to provide a uniform backside illumination profile of the removable medium 302. In one embodiment, the backlight illumination system 706 incorporates one or more apodizing filters, well known in the art, which are provided to create an even illumination profile in an optical system.

The image acquisition optics 703 may incorporate any well-known and commercially available optical components, such as one or more objective lenses, pupils, etc, positioned in the optical path of the camera 701 to enable the camera 701 to acquire a high-resolution image of the removable medium 302.

In one or more embodiments, the inventive software residing on the mobile computing device 100 is configured to cause the camera flash light emitting diode (LED) 702 to be activated every time the mobile computing device 100 acquires an image of the removable medium 302. Due to the described optical configuration of the components of the mobile microscopy device 101, this would result in the synchronous illumination of the removable medium 302. The aforesaid internal components of the mobile microscopy device 101 are mounted onto the housing of the mobile microscopy device 101. The aforesaid housing is also configured to position the removable medium 302 in a proper position inside the mobile microscopy device 101 for optimal image acquisition by the camera 701. To this end, the housing may incorporate appropriate rail or rails for guiding the removable medium 302 during the insertion and removal thereof.

FIG. 8 illustrates another exemplary embodiment of the inventive mobile microscopy device 101 coupled with the mobile computing device 100. In this embodiment, the reflective backside illumination system 706 incorporates two mirrors 801 and 802 for directing the illuminating light from the light guide 705 onto the backside of the removable medium 302, as shown in FIG. 8. Optionally, the shown embodiment may incorporate a filter 803. In one or more embodiments, the filter 803 is an apodizing filter.

FIG. 9 illustrates yet another exemplary embodiment of the inventive mobile microscopy device 101 coupled with the mobile computing device 100. In this embodiment, the reflective backside illumination system is implemented as a light pipe 900 having a light guide portion 902 and illuminating portion 901. In one or more embodiments, the light pipe 900 may comprise a single piece of transparent plastic, such as Poly(methyl methacrylate), acrylic or any other suitable transparent material. In one or more embodiments, the light pipe 900 is coated with a reflective material in order to reduce light leakage. In one or more embodiments, the illuminating portion 901 is wider (has a larger cross-section) than the rest of the light pipe 900 to facilitate the illumination of sufficient area of the removable medium 302.

FIG. 10 illustrates yet another exemplary embodiment of the inventive mobile microscopy device 101 coupled with the mobile computing device 100. In this embodiment, an additional diffuser, filter or apodizing filter 1003 is provided between the backside illuminating portion 901 and the removable medium 302 to create a uniform illumination of the removable medium 302.

FIG. 11 illustrates yet another exemplary embodiment of the inventive mobile microscopy device 101 coupled with the mobile computing device 100. In this embodiment, the reflective backside illumination system is implemented as a light pipe 1100 having a light guide portion 1102 and illuminating portion 1101 shown in FIG. 11. In one or more embodiments, the light pipe 1100 may comprise a single piece of transparent plastic, such as Poly(methyl methacrylate), acrylic or any other suitable transparent material. The shape of the light pipe 1100 differs from the shape of the light pipe 900 in that light pipe 1100 has gradually increasing cross-section from the light guide portion 1102 to the illuminating portion 1101. In one or more embodiments, the light pipe 1100 is coated with a reflective material in order to reduce light leakage.

FIG. 12 illustrates yet another exemplary embodiment of the inventive mobile microscopy device 101 coupled with the mobile computing device 100. In this embodiment, an additional diffuser, filter or apodizing filter 1203 is provided between the backside illuminating portion 1101 and the removable medium 302 to create a uniform illumination of the removable medium 302.

FIG. 13 illustrates yet another exemplary embodiment of the inventive mobile microscopy device 101 coupled with the mobile computing device 100. In this embodiment, instead of the reflective backside illumination system, the mobile microscopy device 101 incorporates a frontside illumination system 1300 comprising a light guide portion 1302 and illuminating portion 1301 shown in FIG. 11. In one or more embodiments, the frontside illumination system 1300 may comprise a single piece of transparent plastic, such as Poly(methyl methacrylate), acrylic or any other suitable transparent material. When the mobile microscopy device 101 is attached to the mobile computing device 100, the camera flash LED 702 of the mobile computing device 100 is placed into optical contact with the frontside illuminator 1300.

FIG. 14 illustrates yet another exemplary embodiment of the inventive mobile microscopy device 101 coupled with the mobile computing device 100. In this embodiment, a visible-to-ultraviolet wavelength shifter 1401 is provided. In addition, a diffuser, filter or apodizing filter (not shown) may be provided between the frontside illuminating system 1300 or 1401 and the removable medium 302 to create a uniform illumination of the microplate array 1307.

FIG. 15 illustrates an exemplary embodiment of a removable medium 302 in the form of a microarray. The microarray 302 may be manufactured, at least partially, of a clear plastic or any other suitable for backside illumination material and may include a material holding portion 1501 and an encoded data portion 1502. The material holding portion 1503 may carry multiple material samples 1503 arranged, for example, into an array-like arrangement within the material holding portion 1501. The encoded data portion 1502 may contain optically encoded information, including bar code, QR array the like. In one or more embodiments, the encoded data portion 1502 carries information on the material samples 1503 in the material holding portion 1503. In one or more embodiments, when the microarray 302 is inserted into the mobile microscopy device 101, both the material holding portion 1503 and the encoded data portion 1502 are within the field of view of the camera 701 of the mobile computing device 100.

In one or more embodiments, the frontside or backside illumination systems perform wavelength shifting of the illuminating light. In one embodiment, the wavelength of the illuminating light is decreased. Specifically, in one embodiment, the illuminating light produced by the wavelength shifter is ultraviolet light. FIG. 16 illustrates an exemplary embodiment of the wavelength shifter. The wavelength shifter incorporates a optical receiver 1600 configured to convert light energy of the camera flash LED 702 into electrical energy. In one or more embodiments, the optical receiver is a photodiode, a phototransistor, a de-capped transistor or an LED. In one or more embodiments, when the mobile microscopy device 101 is attached to the mobile computing device 100, the light entrance of the optical receiver 1600 is brought into optical contact with the LED 702 of the mobile computing device 100.

The wavelength shifter may further incorporate an electrical energy storage unit 1601 configured to store the electrical energy generated by the optical receiver 1600 in response to illumination by the light from the LED 702. In one or more embodiments, the electrical energy storage unit 1601 is a capacitor. The LED 1603 is controlled by the LED control module 1603, which is configured to cause the LED 1603 to illuminate upon receiving one-time or periodic trigger signal received either from the mobile computing device 100 or from additional trigger logic (not shown). In one or more embodiments, the same trigger signal may be used to cause the mobile computing device 100 to acquire an image of the removable medium, such as a slide or microarray 302. In one embodiment, the aforesaid trigger signal may be automatically generated upon the electrical energy storage unit 1601 reaching a predetermined charge level. In one or more embodiments, the LED 1603 is an LED emitting light in the ultraviolet spectral range.

FIG. 17 illustrates an exemplary operating sequence of an image processing algorithm used in connection with an embodiment of the mobile microscopy device 101. Specifically, with reference to FIG. 17, the image of the slide or microarray is captured at step 1701. The image acquired by the camera 701 is analyzed in step 1702. In one or more embodiments, the acquired image analysis may include both the analysis of the acquired image portion corresponding to the material holding portion 1503 and the reading the encoded data from the encoded data portion 1502 of the microarray 302. The information from the encoded data portion may be decoded using a QR code reader or functionally similar software algorithm. The analysis of the image of the material holding portion 1503 is performed using the techniques, which will be described in detail below.

The analyzed image data is sent for classification analysis at step 1703. To this end, reference data 1704 may be obtained from the encoded data portion 1502 of the microarray 302. In an alternative embodiment, the reference data may be stored in one of the data storage units of the mobile computing device 100. After the completion of the classification analysis at step 1703, the results are provided to the user via user interface 1705. Additional image analysis result reporting may be performed at step 1706 and the image analysis results may be sent to one or more remote networking device(s) via a network 1707.

FIG. 18 illustrates an exemplary embodiment of an image acquisition algorithm used in connection with an embodiment of the mobile microscopy device 101. In this embodiment, still images 1801, 1802 and 1803 of the microarray 302 are continuously acquired by the camera 701 resulting in a continuous acquired image stream. In an alternative embodiment, a video of the microarray 302 may be acquired instead of the still images. The acquired still images or video frames are analyzed for one or more image quality parameters at a processing step 1804. In one embodiment, the aforesaid image quality parameters include one or more of image brightness, image contrast, image sharpness and/or any other suitable image quality parameter(s). In one or more embodiments, the aforesaid image analysis step comprises comparing the image quality parameter(s) with a predetermined threshold value.

If it is determined that the image quality parameter(s) satisfy one or more predetermined criteria, the corresponding still image or video frame is grabbed at the frame grab step 1805 and used for further image processing.

In various embodiments, the inventive mobile microscopy device 101 operates in a plurality of operating configurations (modes) including, without limitation, microscope configuration, visible colormatic microarray configuration, and/or fluorescent microarray configuration. The aforesaid operating configurations will now be described in detail.

In one or more embodiments, in the microscope operating configuration, the removable medium 302 may be manufactured from a transparent/translucent material to facilitate the backside illumination of the sample. In one or more embodiments, the removable medium 302 may include well(s). In the aforesaid microscope configuration, the image acquisition optics 703 may be configured to provide a magnification between 100× and 1000×. The sample may be applied fluorescent dyes for enlightening and identifying the targets. In one or more embodiments, the encoded data portion 1502 of the removable medium 302 may include the serial number of the sample, which may be decoded by the application software running on the mobile computing device 100.

In one or more embodiments, in the visible colormatic microarray operating configuration, the removable medium 302 may be arranged in a form of a microarray containing wells having colormatic markers. The ligands in the microarray may include virus, cells, endotoxin, second antibody and antigen, cDNA, glucose, as well as enzyme—catalyzed reaction. In one or more embodiments, the colorimetric materials that are used in the microarray may include, without limitation, PDA, CPRG, X—InP and magenta caprylate, well known in the art.

Colorimetry is utilized to determine the concentration of colored compounds in a solution by measuring the absorbance of a specific wavelength of light. In one or more embodiments, the material(s) in the microarray 302 are analyzed using colorimetry technique well known to persons of skill in the art by measuring maximal wavelength and spectral absorbance. To this end, the frontside illumination configuration of the microarray 302 shown in FIGS. 13 and 14 may be used. In the aforesaid visible colormatic microarray operating configuration, the image acquisition optics 703 may be configured to provide a magnification between 5× and 100×. In accordance with one or more embodiments, the image of the microarray 302 is acquired using the camera 701 and the resulting colorimetric information is extracted from the acquired image and analyzed by the image analysis software executing on the mobile computing device 100. In one or more embodiments, the recognized substrates include β-galactosidase, PI-PLC, esterase, probe DNA, cyclodextrin ligand, hyxokinase, peptide, enzyme substrate, and the like. The recognized substrates, which bound to coloricmetric markers or they have colorimetric properties by themselves, are applied to the medium. The final product from the reaction between the recognized substances and the target substances is able to measure from its color. In one or more embodiments, the encoded data portion 1502 of the microarray 302 may include an optical code with the corresponding microarray description, which may be decoded by the application software running on the mobile computing device 100.

In one or more embodiments, in the fluorescent microarray operating configuration, the removable medium 302 may be arranged in a form of a microarray containing wells having fluorescent immunomarkers. The ligands in the microarray may include virus, cells, endotoxin, second antibody and antigen, cDNA, glucose, as well as enzyme—catalyzed reaction. In one or more embodiments, the fluorescence materials that are used in the microarray may include, without limitation, fluorescent dyes as well as nanoparticle fluorescent polymer conjugate system, well known in the art.

In one or more embodiments, the material(s) in the microarray 302 are analyzed using fluorescent microarray imaging techniques well known to persons of skill in the art by measuring intensity of emissions from the UV irradiated materials. In one or more embodiments, the frontside illumination configuration of the microarray 302 shown in FIGS. 13 and 14 using ultraviolet light may be used. To this end, the wavelength shifter shown in FIG. 16 may be utilized to deliver the ultraviolet illuminating light. In an alternative embodiment, the microarray may be illuminated using an ultraviolet LED powered by an external power source, such as battery. In the aforesaid fluorescent microarray configuration, the image acquisition optics 703 may be configured to provide a magnification between 5× and 100×.

In accordance with one or more embodiments, the image of the microarray 302 is acquired using the camera 701 and the resulting fluorescent imaging information is extracted from the acquired image and analyzed by the image analysis software executing on the mobile computing device 100. In one or more embodiments, the recognized substrates include Carbohydrate, Antibody, probe DNA, cyclodextrin ligand, hyxokinase, peptide, enzyme substrate, and the like. The recognized substrates, which bound to fluorometric markers or they have fluorometric properties by themselves, are applied to the medium. The final product from the reaction between the recognized substances and the target substances is able to measure from its emission. In one or more embodiments, the encoded data portion 1502 of the microarray 302 may include an optical code with the corresponding microarray description, which may be decoded by the application software running on the mobile computing device 100.

FIG. 19 illustrates an exemplary embodiment of a computerized system 100 for performing, among other tasks, image acquisition and analysis in connection with the inventive mobile microscopy device 101. In one or more embodiments, the computerized system 100 may be implemented within the form factor of a mobile computing device, such as a smartphone, a personal digital assistant (PDA), or a tablet computer, all of which are available commercially and are well known to persons of skill in the art. In an alternative embodiment, the computerized system 100 may be implemented based on a laptop or a notebook computer. Yet in an alternative embodiment, the computerized system 100 may be an embedded system, incorporated into an electronic device with certain specialized functions, such as an electronic book (or e-book) reader.

The computerized system 100 may include a data bus 104 or other interconnect or communication mechanism for communicating information across and among various hardware components of the computerized system 100, and a central processing unit (CPU or simply processor) 101 electrically coupled with the data bus 104 for processing information and performing other computational and control tasks. Computerized system 100 also includes a memory 112, such as a random access memory (RAM) or other dynamic storage device, coupled to the data bus 104 for storing various information as well as instructions to be executed by the processor 101. The memory 112 may also include persistent storage devices, such as a magnetic disk, optical disk, solid-state flash memory device or other non-volatile solid-state storage devices.

In one or more embodiments, the memory 112 may also be used for storing temporary variables or other intermediate information during execution of instructions by the processor 101. Optionally, computerized system 100 may further include a read only memory (ROM or EPROM) 102 or other static storage device coupled to the data bus 104 for storing static information and instructions for the processor 101, such as firmware necessary for the operation of the computerized system 100, basic input-output system (BIOS), as well as various configuration parameters of the computerized system 100.

In one or more embodiments, the computerized system 100 may incorporate a display device 109, which may be also electrically coupled to the data bus 104, for displaying various information to a user of the computerized system 100. In an alternative embodiment, the display device 109 may be associated with a graphics controller and/or graphics processor (not shown). The display device 109 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 109 may be incorporated into the same general enclosure with the remaining components of the computerized system 100. In an alternative embodiment, the display device 109 may be positioned outside of such enclosure.

In one or more embodiments, the display device 109 may be implemented in a form of a projector or a mini-projector configured to project information on various objects, such as glasses worn by the user or any part thereof. In one or more embodiments, the display device 109 may be configured to be mountable on the head or other suitable body part of the user. To this end, the display device 109 may be provided with suitable mounting hardware (not shown).

In one or more embodiments, the computerized system 100 may further incorporate an audio playback device 125 electrically connected to the data bus 104 and configured to play various audio files, such as MPEG-3 files, or audio tracks of various video files, such as MPEG-4 files, well known to persons of ordinary skill in the art. To this end, the computerized system 100 may also incorporate waive or sound processor or a similar device (not shown).

In one or more embodiments, the computerized system 100 may incorporate one or more input devices, such as a touchscreen interface 110 for receiving user's tactile commands, including control commands. The touchscreen interface 110 used in conjunction with the display device 109 enables the display device 109 to possess touchscreen functionality. Thus, the display device 109 working together with the touchscreen interface 110 may be referred to herein as a touch-sensitive display device or simply as a “touchscreen.”

The computerized system 100 may further incorporate a camera 111 for acquiring still images and video of various objects, including the images of the slides and microarray 302, as well as a keyboard 106, which all may be coupled to the data bus 104 for communicating information, including, without limitation, images and video, as well as user commands to the processor 101.

In one or more embodiments, the computerized system 100 may additionally include an illumination control module 103 for controlling the illumination of the LED 702.

In one or more embodiments, the computerized system 100 may additionally include a communication interface, such as a network interface 105 coupled to the data bus 104. The network interface 105 may be configured to establish a connection between the computerized system 100 and the Internet 124 using at least one of a WIFI interface 107 and/or a cellular network (GSM or CDMA) adaptor 108. The network interface 105 may be configured to enable a two-way data communication between the computerized system 100 and the Internet 124. The WIFI adaptor 107 may operate in compliance with 802.11a, 802.11b, 802.11g and/or 802.11n protocols as well as Bluetooth protocol well known to persons of ordinary skill in the art. In an exemplary implementation, the WIFI adaptor 107 and the cellular network (GSM or CDMA) adaptor 108 send and receive electrical or electromagnetic signals that carry digital data streams representing various types of information.

In one or more embodiments, the Internet 124 typically provides data communication through one or more sub-networks to other network resources. Thus, the computerized system 100 is capable of accessing a variety of network resources located anywhere on the Internet 124, such as remote media servers, web servers, other content servers as well as other network data storage resources. In one or more embodiments, the computerized system 100 is configured to send and receive messages, media and other data, including application program code, through a variety of network(s) including the Internet 124 by means of the network interface 105. In the Internet example, when the computerized system 100 acts as a network client, it may request code or data for an application program executing on the computerized system 100. Similarly, it may send various data or computer code to other network resources.

In one or more embodiments, the functionality described herein is implemented by computerized system 100 in response to processor 101 executing one or more sequences of one or more instructions contained in the memory 112. Such instructions may be read into the memory 112 from another computer-readable medium. Execution of the sequences of instructions contained in the memory 112 causes the processor 101 to perform the various process steps described herein. In alternative embodiments, hard-wired circuitry may be used in place of or in combination with software instructions to implement the embodiments of the invention. Thus, the described embodiments of the invention are not limited to any specific combination of hardware circuitry and/or software.

The term “computer-readable medium” as used herein refers to any medium that participates in providing instructions to the processor 101 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to the processor 101 for execution. For example, the instructions may initially be carried on a magnetic disk from a remote computer. Alternatively, a remote computer can load the instructions into its dynamic memory and send the instructions over the Internet 324. Specifically, the computer instructions may be downloaded into the memory 112 of the computerized system 300 from the foresaid remote computer via the Internet 124 using a variety of network data communication protocols well known in the art.

In one or more embodiments, the memory 112 of the computerized system 100 may store any of the following software programs, applications or modules:

1. Operating system (OS) 113, which may be a mobile operating system for implementing basic system services and managing various hardware components of the computerized system 100. Exemplary embodiments of the operating system 113 are well known to persons of skill in the art, and may include any now known or later developed mobile operating systems.

2. Applications 114 may include, for example, a set of software applications executed by the processor 101 of the computerized system 100, which cause the computerized system 100 to perform certain predetermined functions, such as acquire images using the camera 111. In one or more embodiments, the applications 114 may include an inventive image acquisition and analysis application 115.

In one or more embodiments, the inventive image acquisition and analysis application 115 may incorporate a user interface generation module 116 for generating a user interface on the display device 109 of the computerized system 100, an image display module 117 for displaying the acquired image on the display device 109 of the computerized system 100, an image recognition module 118 for analyzing the acquired image and optical code reader module 119 for decoding the information encoded in the encoded data portion 1502 of the microarray 302.

Additionally provided may be a networking module 120 for uploading the acquired image(s) to a remote database, performing a remote database data download, facilitating remote image recognition, reporting image analysis results and facilitating collaboration in connection with the acquired images.

3. Data storage 121 may include, for example, an imaging data 122 for storing images acquired using the camera 111. Additionally provided may be results storage 123 for storing the results of the image analysis.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the mobile microscopy device. It is intended that the specification and examples be considered as exemplary only, with a true scope and spirit of the invention being indicated by the following claims.

What is claimed is:

1. A mobile microscopy apparatus usable in connection with a mobile computing device comprising a memory unit and camera, the mobile microscopy apparatus comprising: an illumination module for illuminating a removable medium with an illuminating light, an image acquisition optics for creating an image of the sample for acquisition by the camera of the mobile computing device, and a mounting frame assembly for detachably mounting the illumination module and the image acquisition optics to the mobile computing device and for holding the removable medium in a predetermined position in relation to the illumination module and the image acquisition optics, wherein the memory unit of the mobile computing device comprises:
a. an image acquisition module for acquitting an image of the sample using the camera and an illuminating light;
b. an image analysis module for analyzing the acquired image using image recognition algorithm; and
c. a network communication module for communicating the acquired image across a communication network.

2. The mobile microscopy apparatus of claim 1, wherein illumination module comprises a light guide optically coupled with a light source of the mobile computing device, the light guide configured for delivering the light from the light source of the mobile computing device to the removable medium.

3. The mobile microscopy apparatus of claim 2, wherein the light guide comprises light shielding for reducing light leakage.

4. The mobile microscopy apparatus of claim 1, wherein the illumination module is a backside illumination module configured to illuminate the side of the removable medium opposite to the side of the camera of the mobile computing device.

5. The mobile microscopy apparatus of claim 1, wherein the illumination module is a frontside illumination module configured to illuminate the same side of the removable medium as the camera side.

6. The mobile microscopy apparatus of claim 1, wherein the illumination module comprises a mirror configured to direct a light from a light source of the mobile computing device onto the removable medium.

7. The mobile microscopy apparatus of claim 1, wherein the illumination module comprises a mirror configured to direct a light from a light source of the mobile computing device onto the removable medium.

8. The mobile microscopy apparatus of claim 1, wherein the illumination module comprises a light pipe configured to direct a light from a light source of the mobile computing device onto the removable medium.

9. The mobile microscopy apparatus of claim 8, wherein the light pipe comprises a light guide portion and an illuminating portion.

10. The mobile microscopy apparatus of claim 1, wherein the illumination module comprises a diffuser for improving uniformity of illumination of the removable medium.

11. The mobile microscopy apparatus of claim 1, wherein the illumination module comprises an apodizing filter for improving uniformity of illumination of the removable medium.

12. The mobile microscopy apparatus of claim 1, wherein the illumination module comprises a wavelength shifter.

13. The mobile microscopy apparatus of claim 1, wherein the illumination module comprises an ultra violet light source.

14. The mobile microscopy apparatus of claim 1, wherein the image acquisition optics comprises an objective lens.

15. The mobile microscopy apparatus of claim 1, wherein the removable medium is a microarray.

16. The mobile microscopy apparatus of claim 1, wherein the removable medium comprises a transparent material.

17. The mobile microscopy apparatus of claim 1, wherein the removable medium comprises a material holding portion and an encoded data portion.

18. The mobile microscopy apparatus of claim 1, wherein the image analysis module is configured to analyze the acquired image using a fluorescent microarray imaging technique.

19. The mobile microscopy apparatus of claim 1, wherein the image analysis module is configured to analyze the acquired image using a fluorescent microarray imaging technique.

20. The mobile microscopy apparatus of claim 1, wherein the image analysis module is configured to analyze the acquired image using a colorimetry imaging technique.

21. The mobile microscopy apparatus of claim 1, wherein the removable medium contains chemical or biological substances, which produce colormetric or fluorometric reaction when they expose with the tested targets.
